(19) United States
(12) Patent Application Publication
(10) Pub. No.: US 2005/0111025 A1
(43) Pub. Date: May 26, 2005

(54) System and method for printing print data transmitted via network according to emulation type

(75) Inventor: Woo-chang Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/994,416

(22) Filed: Nov. 23, 2004

(30) Foreign Application Priority Data
Nov. 24, 2003 (KR) 2003-83627

(51) Int. Cl. G06F 15/00

(52) U.S. Cl. 358/1.13; 358/1.15

(57) ABSTRACT

In a method of printing print data transmitted from a computer via a network according to an emulation type, the print data is transmitted to a printer via the network, and an emulation type for printing the print data is determined using information contained in the transmitted print data, after which the print data are printed according to the determined emulation type. The print data contain information indicating an emulation type used for generating the print data.

### PRIORITY

This application claims the benefit under 35 U.S.C. § 119(a) of Korean Patent Application No. 2003-83627, filed on Nov. 24, 2003, in the Korean Intellectual Property Office, the disclosure of which is incorporated herein by reference in its entirety.

### BACKGROUND OF THE INVENTION

1. Field of the Invention

The present invention relates to a printing system. More particularly, the present invention relates to a system and method for printing print data transmitted via a network according to an emulation type.

2. Description of the Related Art

FIG. 1 is a block diagram of a conventional printing system. Print data transmitted from an application program installed in a computer system are converted into printer language by a printer driver 100 which is also installed in the computer system, and is then transmitted to a printer 110 via a parallel interface, a serial interface, a universal serial bus (USB), or a network port.

That is, the data converted into the printer language are transmitted to and stored in a data receiver 120 of the printer 110. A data controller 130 identifies a type of the data stored in the data receiver 120 and processes the same according to the type identified. This will be described in further detail below.

The data controller 130 analyzes the print data using an automatic parser analysis or print job language (PJL) analysis and identifies an emulation type used for generating the print data. The data controller 130 stores print-setting information in storage installed in the printer according to the emulation type. A printing unit 140 prints the print data according to the emulation type identified by the data controller 130.

As described above, in order to identify the print data, the data controller 130 identifies the emulation type used for generating the print data using via the automatic parser analysis or the PJL analysis. Therefore, analyzing time is required, increasing the printing time by an amount equal to the analyzing time.

To solve this problem, a technique for transmitting the print data of the application program to different printers via different interfaces according to the emulation type has been proposed. For example, when a postscript is used as the emulation, the print data are transmitted to a postscript-support-printer connected to the computer via a parallel interface, and when a printer control language (PCL) is used as the emulator, the print data are transmitted to a PCL-support-printer connected to the computer via a local access network (LAN) interface. In this case, however, a variety of printers must be connected to the respective interfaces of the computer, causing many drawbacks such as a cost increase and an inefficiency of space.

### SUMMARY OF THE INVENTION

The present invention provides a system and method for printing print data transmitted via a network which requires a small amount of time for analyzing the emulation type used for the print data.

According to an aspect of the present invention, there is provided a method of printing print data, comprising transmitting the print data generated in a first device via a network, the print data containing information representing an emulation type used for generating the print data; receiving the transmitted data and determining an emulation type for printing the print data using the information contained in the transmitted print data; and printing the print data according to the determined emulation type.

According to still another aspect of the present invention, there is provided a method of printing print data, comprising receiving the print data generated in a first device via a network, the print data containing information representing an emulation type used for generating the print data; determining an emulation type for printing the print data using the information contained in the transmitted print data; and printing the print data according to the determined emulation type.

According to still yet another aspect of the present invention, there is provided a system for printing print data transmitted via a network according to an emulation type, comprising a computer generating print data containing information indicating an emulation type used for generating the print data and transferring the print data via a network; and a printer for receiving the print data via the network, determining the emulation type for printing the print data using the information indicating the emulation type contained in the print data, and printing the print data according to the determined emulation type.

According to still yet another aspect of the present invention, there is provided a system for printing print data transmitted via a network according to an emulation type, the system comprising a network receiving unit for receiving the print data from a computer; an emulation determining unit for determining the emulation type for printing the print data using information indicating the emulation type contained in the print data; and a print control unit for printing the print data according to the determined emulation type.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional printing system;

FIG. 2 is a flowchart illustrating a method of printing print data transmitted via a network according to an emulation type according to an embodiment of the present invention;

FIG. 3 is a block diagram of a printing system for printing print data transmitted via a network according to an emulation type according to another embodiment of the present invention;

FIG. 4 is a view illustrating an example of print data generated according to embodiments of the present invention;

FIG. 5a is a flowchart illustrating a process for generating and transmitting print data from a computer to a printer; and

FIG. 5b is a flowchart illustrating a process of printing print data with a printer.

### DETAILED DESCRIPTION OF THE EXEMPLARY EMBODIMENTS

The present invention will now be described more fully with reference to the accompanying drawings, in which exemplary embodiments of the invention are shown. The invention may, however, be embodied in many different forms and should not be construed as being limited to the embodiments set forth herein. Rather, these embodiments are provided so that this disclosure will be thorough and complete, and will fully convey the concept of the invention to those skilled in the art.

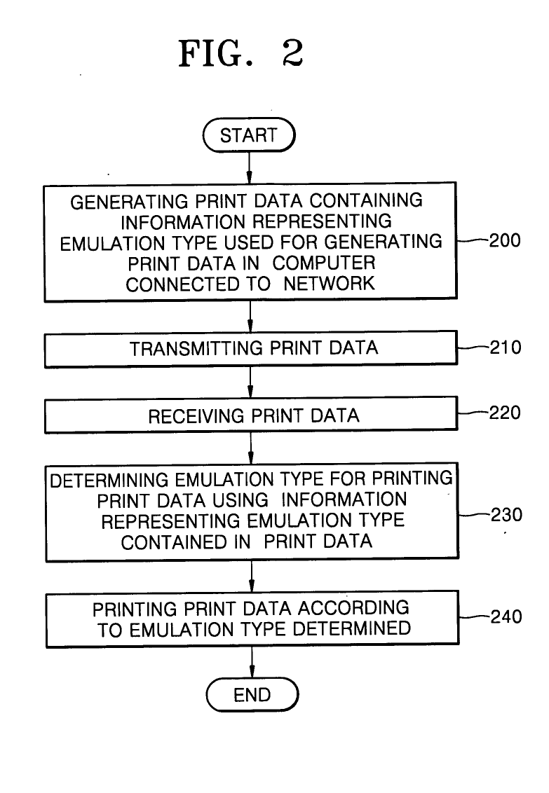

FIG. 2 is a flowchart illustrating a method of printing print data transmitted through a network according to an emulation type according to an embodiment of the present invention.

Referring to FIG. 2, print data containing information indicating an emulation type used for generating the print data are generated by a computer connected to a network 200 and then transmitted to a printer via the network 210 and 220. The emulation type for printing the print data is determined using the information indicating the emulation type contained in the print data 230 and the print data are printed according to the determined emulation type 240.

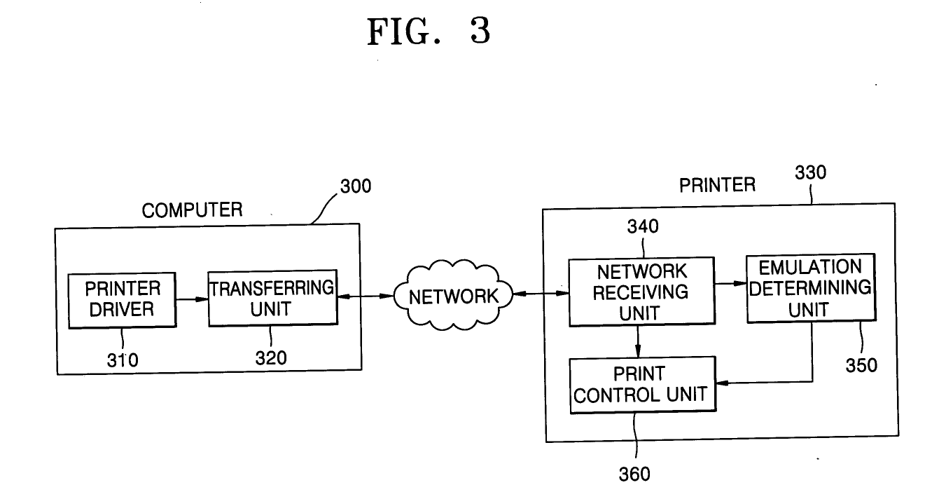

FIG. 3 is a block diagram of a printing system for printing print data transmitted via a network according to an emulation type according to another embodiment of the present invention.

The system comprises a computer 300 for generating print data containing information indicating an emulation type used for generating the print data and transmitting the same via a network, and a printer 330 for receiving the print data from the computer 300, determining the emulation type for printing the print data using the information indicating the emulation type contained in the print data, and printing the print data according to the determined emulation type.

The computer 300 comprises a printer driver 310 for generating the print data containing the information indicating the emulation type used for generating the print data and a transferring unit 320 for transferring the print data to the printer 300 via the network.

The printer 330 comprises a network receiving unit 340 for receiving the print data from the computer 300, an emulation determining unit 350 for determining the emulation type for printing the print data using the information indicating the emulation type contained in the print data, and a print control unit 360 for printing the print data according to the emulation type determined.

Emulation languages are a group of command languages that are transmitted from the computer to the printer to adjust the printing state of the print data. That is, such command languages manage a font size, a graphic, a compression of the data transmitted to the printer, color, and the like. Most widely used as the printer emulation language are postscript and PCL. Each of the emulations includes a variety of versions such as a PCL 5 and a PCL 6.

The emulation support or the version of the emulation may be limited according to the printer, the application program, or the printer driver program. Even some files may be properly printed only by a printer supporting a postscript emulation programmed by the postscript.

As described above, the print data are generated in accordance with an emulation that can be supported by the printer. If there are a variety of emulations that can be supported by the printer, one of the emulations can be selected in accordance with the application program or by the user.

The printer driver 310, which can be realized by software, generates the print data containing the information indicating the emulation type used for generating the print data 200. The print data are generated with the information indicating the emulation type as well as with the real print data. The print data are then transmitted to the printer 300 via the transmitting unit 320 having a network interface function. The transferring unit 320 can be realized using, for example, a LAN interface installed in the computer 300.

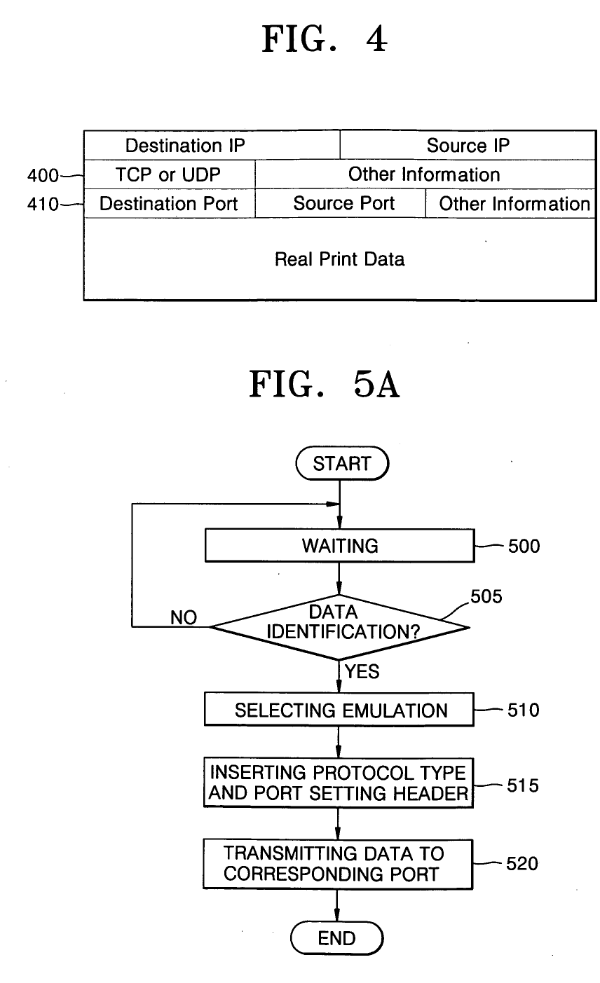

FIG. 4 shows a print data structure according to embodiments of the present invention.

When the computer 300 and the printer 330 are connected via a network according to an Internet protocol (IP), the print data are generated according to IP formation having a variety of fields indicating a destination IP corresponding to the printer 330, a source IP corresponding to the computer 300, a transmission protocol type 400, and a destination port 410. The fields form a header, and successive print data are added adjacent to the header.

That is, the computer 300 generates the print data according to the IP formation having a variety of fields indicating the destination IP, the source IP, the transmission protocol type, and the destination port. The emulation type may be determined by the combination of values of the transmission protocol type and the destination field. That is, the emulation determining unit 350 determines the emulation type according to the combination of the values of the transmission protocol type and the destination field contained in the print data.

The transmission protocol type can be selected from the group consisting of a transmission control protocol (TCP) and a user datagram protocol (UDP). The emulation type can include the PCL and the postscript.

An example of a conversion table for the protocol and the port number according to the emulation type is shown in Table 1.

TABLE 1

| Emulation | Protocol | Port No. |
|---|---|---|
| PCL5 | UDP | 7622 |
| PCL5e | UDP | 7877 |
| PCL6 | UDP | 4823 |
| Postscript | TCP | 4227 |

Table 1 is referenced by both the printer driver 310 of the computer 300, which generates the print data, and the emulation determining unit 350 of the printer 330, which determines the emulation type by receiving the print data from the computer and is preset according to an embodiment of the present invention. However, many other variations of the assignments of the conversion table are possible. When the number of emulation types is increased, each of the emulations can be determined by variably combining the protocols and the port numbers.

The computer 300 generates the print data shown in FIG. 4 and transmits the same to the printer 330. The port number of the data transmitted via the network varies in accordance with a service method used for the network. Accordingly, in Step 100, the print data can be transmitted via a destination port identified by the transmission protocol contained in the print data.

That is, as shown in Table 1, the print data generated by the PCL 5 emulation is preferably transmitted via a port assigned to port number 7622. At this point, the printer 330 generates a port assigned to the port No. 7622 to receive the print data via the network.

The print data shown in FIG. 4 are transmitted to a printer corresponding to the source IP via the network according to the IP protocol 210.

The network receiving unit 340 of the printer 330 receives the print data having the IP value assigned to the printer 330 (Step 220), and the emulation determining unit 350 determines the emulation type of the print data with reference to the transmission protocol type 400 and the destination port 410 representing the emulation type in the print data 230.

At this point, when the small number of fields (five fields in FIG. 4) are received by the network receiving unit 340, since the emulation type required for printing the print data can be identified in the emulation determining unit 350, the printing time, especially the time for printing the first page, can be reduced. Particularly, since five fields are located on the header, the printing time can be further reduced.

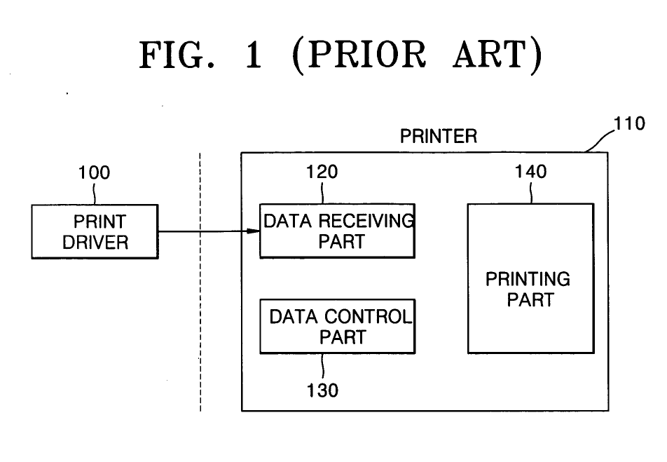

The print control unit 360 processes the print data according to the emulation type determined by the emulation determining unit 350 and prints the print image 240. That is, the print control unit 360 processes real print data according to the emulation type determined by the emulation determining unit 350, generates image data in units of pages, and prints the image data. The print control unit 360 includes functions of the data control unit 130 and the printing unit 140 of a conventional printing system depicted in FIG. 1.

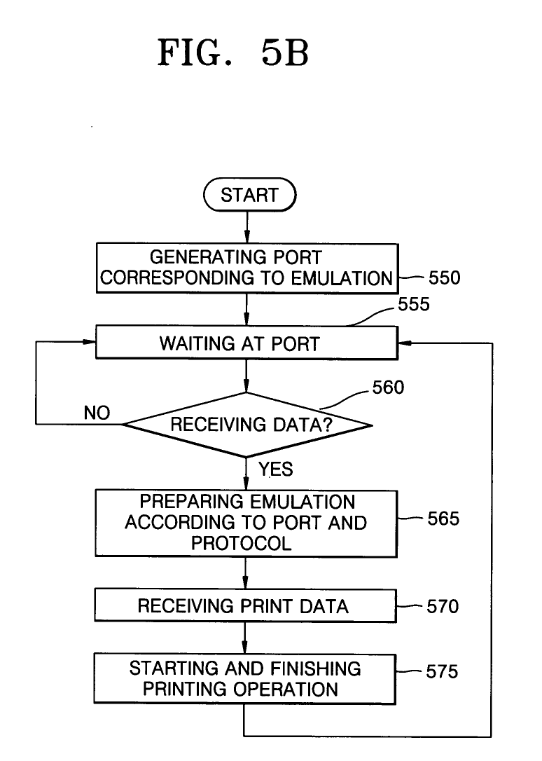

FIG. 5a is a flowchart illustrating a process of transmitting the print data from the computer 300, and FIG. 5b is a flowchart illustrating a process for printing the transmitted print data in the printer 330.

The print driver 310 waits for a print request from an application program 500. When the print data are identified after receiving the print request from the application program 505, an emulation required for printing the data is selected 510. The emulation can be selected according to an assignment of the application program or a pre-assigned emulation type.

The print driver 310 generates a header by setting values of a protocol and a destination port corresponding to the emulation type according to a preset rule as shown in Table 1, after which it further generates the print data as shown in FIG. 4 by inserting the header into the print data 515. The generated print data are transmitted to the printer 330 by the transferring unit 320 via the port set in the header of the print data 520.

The printer 330 may be assigned with a value of the source IP included in the header of the print data. When a network location of the printer 330 is changed, the value of the source IP is also changed in response thereto.

The network receiving unit 340 of the printer 330 generates a port according to a supporting emulation 550 and stands by until the print data are input 555. The network receiving unit 340 receives the data having an IP value corresponding to the printer. That is, the network receiving unit 340 receives the data by a port generated according to the value of the field 410 corresponding to the port. For example, when the printer supports the PCL5, the network receiving unit 340 generates the 7622 port and waits for the print data.

When the print data are received 560, the emulation determining unit 350 determines the emulation type according to the protocol and port contained in the print data and transmits the same to the print control unit 360 so that the print control unit 360 can prepare for the operation according to the emulation required for printing 565.

Since the information regarding the port number is already known by the print data inputted via the port that is already generated, the emulation will be determined by reading the field value corresponding to the protocol type when the process is performed as shown in FIG. 5b 560.

Since the emulation can be prepared in a state where only the header is inputted in the emulation determining unit 350 via the network receiving unit 340, the print control unit 360 receives subsequent print data that are inputted via the network receiving unit 340 570 and prints the real print data 575, after which the printer 330 returns to a state of waiting for the next data input 555.

In the above description, although the computer 300 generating the print data is connected to the printer 330 via the IP network, the present invention is not limited to this case. That is, the present invention can be applied to a case where the computer is connected to the printer in parallel or by a USB interface network. Likewise, the present invention can be applied to a case where the computer is connected to the printer via a variety of interfaces such as a small computer system interface (SCSI), IEEE 1394, an infrared data association (IrDA), and Bluetooth.

That is, via the interfaces, one or more computers can be connected to one or more printers. For example, when the USB interface is used, 127 devices can be connected via the USB interface. If required, a USB hub can be used to constitute the USB network. In addition, when a parallel or serial interface is used and each interface uses a dedicated printer connector, a plurality of computers can be connected to a plurality of printers by each interface.

The present invention can be applied to a variety of networks constituted by interfaces in addition to the IP network by being properly modified within a scope of the present invention.

When the parallel network, the serial network, the USB network, the IrDA network, or a local area mobile network such as Bluetooth is used as the interface, the printer driver of the computer generates the print data containing the information indicating the emulation type used for generating and printing the print data. The printer receives the print data, determines the emulation type contained in the print data, and prints the print data. This process can be easily realized by those of ordinary skill in the art when they refer to the above-described embodiment of the network example by IP.

In addition, even when using other types of networks, when the information indicating the emulation type is contained in the header of the print data, the printing speed can be further increased. That is, the header of the print data is firstly received and processed according to the present invention, and the successive print data can be printed based on the processing results according to an embodiment of the present invention.

As described above, the present invention provides a method of printing print data by transmitting the print data generated in a first device via a network, the print data containing information indicating an emulation type used for generating the print data, determining an emulation type for printing the print data using the information contained the transmitted print data; and printing the print data according to the determined emulation type. Since there is no need to set a printer in response to the emulation type for printing, the printing can be effectively realized. That is, in the conventional art, the printer had to locate the information regarding the emulation contained in the print data. However, according to embodiments of the present invention, since the information of the emulation can be quickly determined, the printing time, especially the time for printing the first page, can be reduced. That is, the printing environment can be improved for the user.

While the present invention has been particularly shown and described with reference to exemplary embodiments thereof, it will be understood by those of ordinary skill in the art that various changes in form and details may be made therein without departing from the spirit and scope of the present invention as defined by the following claims.

In addition, it should be understood that each process of embodiments of the present invention could be realized by software or hardware.

1. A method of printing print data, comprising:
transmitting the print data generated in a first device via a network, the print data containing information representing an emulation type used for generating the print data;
receiving the transmitted data and determining an emulation type for printing the print data using the information contained in the transmitted print data; and
printing the print data according to the determined emulation type.

2. The method of claim 1, wherein a variety of devices including the first device are interconnected via the network by IP protocols;
the print data having a variety of fields indicating a destination IP corresponding to a printer, a source IP corresponding to the first device, a transmission protocol type, and a destination port are generated according to a formation of an IP packet; and
the emulation type is determined by a combination of values of the transmission protocol type and the destination port field.

3. The method of claim 2, wherein, when determining the emulation type, the print data are transmitted via the destination port indicated by a transmission protocol contained in the print data.

4. The method of claim 2, wherein the transmission protocol type is one of TCP and UDP.

5. The method of claim 3, wherein the transmission protocol type is one of TCP and UDP.

6. The method of claim 1, wherein the emulation type is one of PCL and postscript.

7. The method of claim 2, wherein the emulation type is one of PCL and postscript.

8. A method of printing print data, comprising:
receiving the print data generated in a first device via a network, the print data containing information representing an emulation type used for generating the print data;
determining an emulation type for printing the print data using the information contained in the transmitted print data; and
printing the print data according to the determined emulation type.

9. The method of claim 8, wherein a variety of devices including the first device are interconnected via the network by IP protocols;
the print data having a variety of fields indicating a transmission protocol type and a destination port are generated according to a formation of an IP packet; and
the emulation type is determined by a combination of values of the transmission protocol type and the destination port field.

10. The method of claim 8, wherein the transmission protocol type is one of TCP and UDP.

11. The method of claim 9, wherein the transmission protocol type is one of TCP and UDP.

12. The method of claim 8, wherein the emulation type is one of PCL and postscript.

13. The method of claim 9, wherein the emulation type is one of PCL and postscript.

14. A system printing print data transmitted via a network according to an emulation type, comprising:
a computer for generating print data containing information indicating an emulation type used for generating the print data and transferring the print data via a network; and
a printer for receiving the print data via the network, determining the emulation type for printing the print data using the information indicating the emulation type contained in the print data, and printing the print data according to the determined emulation type.

15. The system of claim 14, wherein the computer and the printer are interconnected via the network by IP protocols;
wherein the computer generates the print data having a variety of fields indicating a destination IP corresponding to a printer, a source IP corresponding to the first device, a transmission protocol type, and a destination port according to a formation of an IP packet; and
wherein the printer determines the emulation type using a combination of values of the transmission protocol type and the destination port field.

16. The system of claim 14, wherein the transmission protocol type is one of TCP and UDP and the emulation type is one of PCL and postscript.

17. A system for printing print data transmitted via a network according to an emulation type, the system comprising:
a network receiving unit for receiving the print data from a computer;
an emulation determining unit for determining the emulation type for printing the print data using information indicating the emulation type contained in the print data; and
a print control unit for printing the print data according to the determined emulation type.

18. The system of claim 17, wherein the computer and the network receiving unit are interconnected via the network by IP protocols;
wherein the computer generates the print data having a variety of fields indicating a destination IP corresponding to a printer, a source IP corresponding to the first device, a transmission protocol type, and a destination port according to a formation of an IP packet; and
wherein the network receiving unit determines the emulation type using a combination of values of the transmission protocol type and the destination port field.

19. The system of claim 17, wherein the transmission protocol type is one of TCP and UDP and the emulation type is one of PCL and postscript.

20. The system of claim 18, wherein the transmission protocol type is one of TCP and UDP and the emulation type is one of PCL and postscript.
